(19) United States
(12) Patent Application Publication
(10) Pub. No.: US 2022/0135834 A1
(43) Pub. Date: May 5, 2022

(54) TWO-PART HYDROPHOBIC POLYURETHANE FORMULATIONS FORMING CORROSION RESISTANT COATING

(71) Applicant: Chemical Dynamics, LLC, Plymouth, MI (US)

(72) Inventors: Ronald J. Lewarchik, Plymouth, MI (US); Atman Fozdar, Plymouth, MI (US); Raviteja Kommineni, Plymouth, MI (US)

(73) Assignee: Chemical Dynamics, LLC, Plymouth, MI (US)

(21) Appl. No.: 17/514,258

(22) Filed: Oct. 29, 2021

Related U.S. Application Data
(60) Provisional application No. 63/106,976, filed on Oct. 29, 2020.

(51) Int. Cl. C09D 175/06; C09D 5/08; C08G 18/10; C08G 18/42; C08G 18/73; C08G 18/75; C08G 18/76

(52) U.S. Cl. CPC C09D 175/06; C09D 5/08; C08G 18/10; C08G 18/7671; C08G 18/73; C08G 18/755; C08G 18/7621; C08G 18/4236

(57) ABSTRACT

A two-part polymerizable formulation that upon mixing includes a saturated aliphatic polyester prepolymer present in an amount of between 10 to 65 weight percent of the total formulation having a viscosity of between 100 and 955 cP at 25° C. An organic solvent is present in an amount of between 25 to 55 weight percent of the total formulation. An additive of hexamethylene diisocyanate trimer, isophorone diisocyanate dimer or trimer, toluene diisocyanate or methylene diphenyl diisocyanate, or combinations thereof is present in an amount of 17 to 25 weight percent of the total formulation. A process of forming a polymerized coating on an article includes the application of the formulation to a substrate of the article. After allowing sufficient time and temperature for solvent to evaporate to accelerate a rate of cure of the polymerizable compound to form a polymerized coating on the article.

### RELATED APPLICATIONS

This application claims priority benefit of US Provisional; Application Ser. No. 63/106,976 filed 29 Oct. 2020; the contents of which are hereby incorporated by reference.

### FIELD OF THE INVENTION

The present invention in general relates to a two-part hydrophobic polyurethane formulation well suited for coatings and in particular, for a topcoat used in conjunction with two-component rust encapsulating hydrophobic primer as two-coat corrosion resistant system.

### BACKGROUND OF THE INVENTION

Corrosion is responsible for losses over $2.5 trillion of global losses every year. Corrosion of steel, including mild steels such as rolled steels, is one of the major issues faced by the transport industry (e.g. automobiles, aircraft, ships, etc.) and infrastructure (e.g. pipelines, buildings, bridges, oil rigs, refinery etc.), directly affecting the structural integrity of these vital assets. As a result, safety and maintenance of steel structures is a constant and time-consuming concern in terms of both time and replacement materials. Accordingly, attempts have been made to advance technologies to protect surfaces from corrosion.

There are different methods to counter corrosion such as, using corrosion inhibitive lining, electroplating, organic polymeric coatings, and chemical vapor deposition. Applying protective organic coatings to metallic substrates, especially aluminum and steel, is an effective way to protect those substrates against severe corrosion environments. Organic coatings can minimize corrosion of metallic substrates by three main mechanisms: barrier formation, sacrificial coating, and inhibition.

Corrosion on a structure appear for a variety of reasons, such as: poor surface preparation, poor application of protective coatings, compromised coatings during handling or fabrication, or external environmental factors such as acid rain, high humidity, salinity exposure, temperature variations, condensation of moisture, chemical fumes and dissolved gases (in case of structures submerged in water or set in soil). Microcracks formed within coating matrix also result from exposure to factors such as environmental exposure, mechanical forces, stresses induced during installation of the structure. Due to formation of these microcracks, environmental elements migrate into contact with the substrate and initiate corrosion.

The protection of a surface with a polymeric coating requires extensive removal of surface debris, grease, and other liquids from the surface, else the applied coating will have poor adhesion that reduces the coating lifetime and exposes the substrate to environmental exposure. These difficulties are compounded when higher molecular weight polymer precursors are used that, owing to size and conformational limitations, are unable to permeate well into a porous or scaly substrate.

Even upon addressing of these surface preparation issues and handling and application issues, in terms of performance, providing coatings to protect metal substrates from salt corrosion remains an ongoing problem. It is appreciated that in many marine settings, such as oil rigs, wind turbines, pilings, and ships; treating corrosion and maintenance work dwarfs the initial installation cost. In spite of the long-standing problem, few suitable polymeric coating options exist to inhibit salt corrosion.

Owing to the aforementioned limitations, there exists a need for a flexible protective coating with volumetric hydrophobic characteristics. There further exists a need for such a formulation that is amenable to spray, roll or brush application. There further exists a need for a formulation that cures to a coating with excellent anti-corrosion properties.

### SUMMARY OF THE INVENTION

A two-part polymerizable formulation that upon mixing includes a saturated aliphatic polyester prepolymer present in an amount of between 10 to 65 weight percent of the total formulation having a viscosity of between 100 and 955 cP at 25° C. An organic solvent is present in an amount of between 25 to 55 weight percent of the total formulation. An additive of hexamethylene diisocyanate trimer, isophorone diisocyanate dimer or trimer, toluene diisocyanate or methylene diphenyl diisocyanate, or combinations thereof is present in an amount of 17 to 25 weight percent of the total formulation. The formulation has an overall viscosity that allows the formulation to penetrate a substrate to which the formulation is applied.

A process of forming a polymerized coating on an article includes the application of the formulation to a substrate of the article. After allowing sufficient time and temperature for solvent to evaporate to accelerate a rate of cure of the polymerizable compound to form a polymerized coating on the article.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a contact angle of the inventive hydrophobic coating made using HA;

FIG. 2A is photograph of blasted cold rolled steel (CRS) panel coated with commercial control coating described in Example 1 after 2,500 hours of salt spray testing per ASTM B117;

FIG. 2B-I are photographs of blasted cold rolled steel (CRS) panels coated with inventive coating described in example(s) 2-9 respectively, after 2,500 hours of salt spray testing per ASTM B117;

FIG. 3A-D are photographs of zinc-nickel coated steel panels coated with inventive coating described in Example(s) 12, 14, 13 & 11 respectively, after 10,000 hours of salt spray testing per ASTM B117.

### DETAILED DESCRIPTION OF THE PREFERRED EMBODIMENTS

The present invention has utility as a polymerizable formulation from which a coating is formed upon application to a substrate. The coating is hydrophobic, flexible, and confers corrosion protection to an underlying substrate. The inventive formulation is amenable to spray, roll, or brush application. According to some inventive embodiments, hydrophobicity is imparted to the coating through the inclusion of surface treated diatomaceous earth. An inventive formulation is able to penetrate the surface of a fouled substrate prior to polymerization thereby allowing for protective coating to be applied to a substrate with limited or no substrate preparation prior to application of the inventive formulation, compared to, and in contrast to prior art formulations. Representative fouled substrates to which an inventive formulation is directly applied illustratively include corroded metals such as rusted steel, oxidized aluminum, anodized aluminum, pickled steel, stainless steel, painted metals, hot dipped galvanized steel, GALFAN®, GALVALUME®, ZINCALUME®; cement; concrete; wood substrates such as painted wood, partially rotted wood, fabrics, drywall and plastics with porous surfaces as well as fiberboard. An inventive formulation is particularly well suited for formulation as an aerosol with a gaseous propellant. An attribute of a coating produced by an inventive formulation is that an air and moisture barrier is formed that inhibits subsequent corrosion of a substrate, even when already overlayered with a corrosion layer. An inventive formulation can be applied on primed or unprimed substrates such as detailed in exemplary form above.

As used herein. “molecular weight” refers to number average molecular weight in the context of polymers and prepolymers, unless noted otherwise.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

A first component of the inventive formulation includes low molecular weight saturated aliphatic polyester prepolymers with hydroxyl equivalent weight between 150-1,187 grams per equivalent (g/eq) present from 10 to 65 total weight percent and in some inventive embodiments between 13 to 48 weight percent of total formulation. Polyester prepolymers in particular inventive embodiments are a diol, a triol, or a mixture thereof. The molecular weight of prepolymer is between 450 to 20,000 Da. Such low molecular weight polyester prepolymers operative herein have acid values between 0.01 and 0.5 and specific gravity values between 9 and 10.14 lb/gal at 25° C. Viscosity of such polyester prepolymer are typically between 100 and 955 cP at 25° C. Corrosion resistance is further improved when this resin blend is coupled with corrosion inhibitor pigments such as organically modified-zinc,-aluminum,-molybdenum salts such as orthophosphates, hydrates thereof, and in a specific example zinc-5-nitroisophthalate.

According to some inventive embodiments, a suitable flow modifier additive is added to an inventive formulation illustratively include suitable flow and leveling modifier based on acrylic polymers with an acid value of between 0.5 and 1.99. The viscosity of such flow modifier is typically between 15 and 23 s according to the present invention when measured with Ford #4 cup. It is appreciated that the flow modifier is added as to the part A, part B, or both parts of the formulation.

According to inventive embodiments, the formulation additionally includes an organic solvent added to the part A, part B, or both parts of the formulation. A suitable organic solvent operative herein illustratively include suitable solvents classified as exempt Volatile Organic Compounds (VOC) solvents by US EPA such as acetone, methyl acetate, ethyl acetate, butyl acetate, t-butyl acetate, dimethyl carbonate, 2-amino-2-methyl-1 propanol, parachlorobenzotrifluoride as well as other solvents such as toluene, butanol, ethyl ethyl ketone, xylene, tetrahydrofurane, arometic 100, 150 or 200, C₂-C₆ acetates such as n-propyl acetate, and n-hexyl acetate and 2-butoxy-ethanol, other ethylene or propylene glycol based ether solvents. The organic solvent is selected so as to impart solubility on reactive polyester prepolymer compound. Preferably, parachlorobenzotrifluoride constitutes majority component of organic solvent present. The organic solvent is typically present from a 25 to 55 weight percent of fully formulated inventive formulation. An organic solvent or a mixture of solvents is selected not only to solubilize polyester prepolymer compound but also to provide a balance of volatility to provide acceptable flow and leveling upon application and volatilize rapidly relative to reaction rate as residual solvent can diminish barrier properties of a coating formed from an inventive formulation.

In some inventive embodiments, 0.1 to 5 total weight percent of a low surface tension solvent greatly improves the contact angle to provide superhydrophobicity with contact angles of from 130 to 160 degrees. Low surface tension solvents operative herein include cyclosiloxanes (e.g. dimethicone), perfluor C₆-C₁₂ alkanes, polydimethyl siloxanes, and combinations thereof.

Other optional additives added to the first component of an inventive formulation illustratively include fillers and pigments such as titanium dioxide, extenders such as barium sulfate, calcium carbonate, wollastonite; plasticizers, colorants and cure inhibitors.

Fillers operative in an inventive formulation illustratively include particulate of silica, diatomaceous earth, glass microspheres, polymeric microspheres and combinations thereof. Fillers and pigments are typically present from 0-32 weight percent of total formulation. Fillers are appreciated to affect the hardness of a resultant coating formed from an inventive formulation and modify the rheology of the formulation. HA is appreciated to be a filler that can modify the bonding characteristics and the hydrophobicity of the formulation. According to embodiments, the formulation may include HA. Such HA produce a volumetric hydrophobic coating. Accordingly, even if a surface coated with the formulation is abraded, the underlying layers of the formulation still repel water and soluble salts.

An optional pigment and/or colorant added to the first component of inventive formulation is included to provide opacity, color, enhance environmental properties such as moisture and corrosion resistance and help provide improved physical properties such as hardness and abrasion resistance of a resultant coating formed from an inventive formulation. A colorant is typically present from 0 to 31 weight percent and preferably from 1.5 to 21 of total weight percent. Pigments and colorants operative herein include organic, inorganic and mixed metal oxide pigments, such as carbon black, titanium dioxide, phthalol blue, quinacridone red, red iron oxide, copper chrome black, extender pigments such as talc, barytes, silica, calcium carbonate, clay, and corrosion inhibitive pigments normally comprised of sacrificial metal such as zinc of comprised of metal ions (cations) derived from: zinc, strontium, chromium, lead, molybdenum, aluminum, calcium or barium and anions, such as those derived from phosphorous (orthophosphoric and polyphosphoric acids), chromic acid and boric acid as well as soluble and insoluble dyes and combinations thereof.

According to some inventive embodiments, an inventive formulation includes a cure accelerator added to the part A of inventive formulation. Optionally, a cure accelerator is provided to modify the kinetics and progression of the polymerization process. Accelerators operative herein include polyorganometallic catalysts such as stannous (tin II), monobutyltin, dibutyltin, and dioctyltin catalysts dibutyltin dilaurate preferably from 0.01 to 0.2 total weight percent. Cure accelerators are particularly used to accelerate formation of polyurethane linkages. Other cure accelerators may include salts of transition metals such as vanadium, molybdenum, cobalt, iron, zirconium, calcium, strontium, or copper. Of these transition metals, a combination of cobalt and manganese is known to the art to promote surface cure relative to through cure while zirconium or a combination of cobalt and zirconium and strontium facilitates through cure. Cobalt accelerators, zirconium and/or strontium accelerators, and a combination thereof are known to induce oxidation. Suitable accelerator salts operative herein include naphthenates, acetyl acetonates, and 2-ethyl hexanoic acid. In instances when an accelerator is present, an anti-skinning agent such as an aliphatic keto oxime may be provided to control surface oxidation associated with transition metal accelerator. Other anti-skinning agents are available as well as phenolics, nonylphenolics and oxime free anti-skinning agents from suppliers such as OMG trade named Ascinin (Skino #2) may also be used. Representative aliphatic keto oximes include methyl ethyl keto oxime, methyl propyl keto oxime, methyl tertbutyl keto oxime, and methyl isobutyl keto oxime.

A second component of the inventive formulation includes hexamethylene diisocyanate trimer, isophorone diisocyanate dimer or trimer, toluene diisocyanate or methylene diphenyl diisocyanate or combinations thereof. Isocyanate oligomers are present between 17 and 25 weight percent and typically has a viscosity between 850-1420 mPa·s. As used herein, this is also denoted as HA additive.

Once both components of part A and part B are thoroughly mixed and applied onto substrate, Polyurethane linkages are formed by reaction of polyester prepolymer with diisocyanate oligomer in the presence of catalyst or cure accelerator at room temperature.

An inventive formulation is able to penetrate a corrosion overlayer and bond to an underlying substrate. In some inventive embodiments, the cross-linking density is such that an inventive coating forms an air and moisture barrier to inhibit subsequent corrosion. To achieve such a result, an inventive formulation is greater than 30 total weight percent solids as measured by heat cured weight relative to the as-applied formulation. In still other inventive embodiments, the formulation is greater than 50 total weight percent solids upon cure and in still other embodiments is between 60 and 92 total weight percent solids. It is appreciated that higher percent solids formulations tend to have higher initial viscosities and higher coating densities relative to lower percent solids.

It is appreciated that only a thin coating of between 10 and about 500 microns is needed to adequately protect a typical substrate. While an inventive formulation is readily applied to a substrate by swabbing or pump spray, it is appreciated that coating uniformity is readily obtained by application by air or airless spray, brush, roller, aerosol spray, direct or indirect roll coat. For aerosol spray or pump spray application, a propellant is optionally added in a range from 5 to 95 total weight percent with the proviso that the propellant and diluent solvent together do not exceed 97 total weight percent of the formulation. Suitable propellants include those that are unreactive towards the capped silanol fluid and illustratively include alkanes such as butane, pentane, isobutane, propane; ethers such as dimethyl ether, diethyl ether, nitrogen; halogenated hydrocarbons; carbon dioxide and combinations thereof. The resultant formulation inclusive of a propellant is sealed within a conventional metal aerosol canister and applied by spray application. Upon complete cure, typically greater than 72 hours, an inventive coating is amenable to reapplication of an inventive formulation or a conventional paint application. Suitable paints include oil-based, latex, and water-based paints. The present invention is further detailed with respect to the following nonlimiting examples.

### Example 1

Commercial two-component water repellent polyurethane paint is applied on shot blasted cold rolled steel panels between 25-500-micron film thickness, preferably 45-300-micron film thickness, primed with commercial two component zinc-rich epoxy primer applied at 25-250-micron film thickness, preferably 28-150-micron film thickness and allowed to cure at 25° C. for a period of 7 days prior to testing.

### Example 2

First component of an inventive formulation is prepared by adding 8.62 g polyester prepolymer of hydroxyl equivalent weight of 200-280 g/eq to 5.14 g of polyester prepolymer with hydroxyl equivalent weight of 350-450 g/eq. 0.08 g of commercial flow and leveling additive, 0.46 g of pigment wetting and dispersing additive, 20.91 g of titanium dioxide, 0.36 g of fumed silica, 12.64 g of HA additive and 41.05 g of parachlorobenzotrifluoride are added to the mixture. 0.14 g of 10% solution of dibutyltin dilaurate in toluene is added to above mixture in letdown stage. For the preparation of second component, 10.63 g of diisocyanate oligomer solution is prepared by adding 0.77 g parachlorobenzootrifluoride solvent to 9.83 g of hexamethylene diisocyanate trimer having NCO equivalent 180-250 g/eq. Second component is thoroughly mixed with first component for form inventive formulation having pot life of 8 hours. Inventive composition is applied on shot blasted cold rolled steel panels between 25-500-micron film thickness, preferably 45-300-micron film thickness, primed with commercial two component zinc-rich epoxy primer applied at 25-250-micron film thickness, preferably 28-150-micron film thickness and allowed to cure at 25° C. for a period of 7 days prior to testing.

### Example 3

First component of an inventive composition is prepared by adding 0.08 g of commercial flow and leveling additive and 0.15 g of wetting and dispersing additive to 25.66 g of polyester prepolymer. 52.01 g of parachlorobenzotrifluoride solvent is added to mixture along with 18.49 g of HA additive. 3.47 g of titanium dioxide pigment is added to mixture and ground to Hegman grind scale of 7+. 0.13 g of 10% solution of dibutyltin dilaurate in toluene is added to above mixture in letdown stage. 12.83 g of diisocyanate oligomer is added as second component to first component. Inventive formulation has pot life of 8 hours. Inventive composition is applied on shot blasted cold rolled steel panels between 25-500-micron film thickness, preferably 45-300-micron film thickness, primed with commercial two component zinc-rich epoxy primer applied at 25-250-micron film thickness, preferably 28-150-micron film thickness and allowed to cure at 25° C. for a period of 7 days prior to testing.

### Example 4

Commercial two-component water repellent polyurethane paint is applied on shot blasted cold rolled steel panels between 25-500-micron film thickness, preferably 45-300-micron film thickness, primed with inventive two-component rust encapsulating polymeric penetrant having vinyl and oxidative cure mechanisms at 25-250-micron film thickness, preferably 28-150-micron film thickness and allowed to cure at 25° C. for a period of 7 days prior to testing.

### Example 5

First component of an inventive formulation is prepared by adding 8.62 g polyester prepolymer of hydroxyl equivalent weight of 200-280 g/eq to 5.14 g of polyester prepolymer with hydroxyl equivalent weight of 350-450 g/eq. 0.08 g of commercial flow and leveling additive, 0.46 g of pigment wetting and dispersing additive, 20.91 g of titanium dioxide, 0.36 g of fumed silica, 12.64 g of HA additive and 41.05 g of parachlorobenzotrifluoride are added to the mixture. 0.14 g of 10% solution of dibutyltin dilaurate in toluene is added to above mixture in letdown stage. For the preparation of second component, 10.63 g of diisocyanate oligomer solution is prepared by adding 0.77 g parachlorobenzootrifluoride solvent to 9.83 g of hexamethylene diisocyanate trimer having NCO equivalent 180-250 g/eq. Second component is thoroughly mixed with first component for form inventive formulation having pot life of 8 hours. Inventive composition is applied on shot blasted cold rolled steel panels between 25-500-micron film thickness, preferably 45-300-micron film thickness, primed with inventive two-component rust encapsulating polymeric penetrant having vinyl and oxidative cure mechanisms at 25-250-micron film thickness, preferably 28-150-micron film thickness and allowed to cure at 25° C. for a period of 7 days prior to testing.

### Example 6

First component of an inventive composition is prepared by adding 0.08 g of commercial flow and leveling additive and 0.15 g of wetting and dispersing additive to 25.66 g of polyester prepolymer. 52.01 g of parachlorobenzotrifluoride solvent is added to mixture along with 18.49 g of HA additive. 3.47 g of titanium dioxide pigment is added to mixture and ground to Hegman grind scale of 7+. 0.13 g of 10% solution of dibutyltin dilaurate in toluene is added to above mixture in letdown stage. 12.83 g of diisocyanate oligomer is added as second component to first component. Inventive formulation has pot life of 8 hours. Inventive composition is applied on shot blasted cold rolled steel panels between 25-500-micron film thickness, preferably 45-300-micron film thickness, primed with inventive two-component rust encapsulating polymeric penetrant having vinyl and oxidative cure mechanisms at 25-250-micron film thickness, preferably 28-150-micron film thickness and allowed to cure at 25° C. for a period of 7 days prior to testing.

### Example 7

Commercial two-component water repellent polyurethane paint is applied on shot blasted cold rolled steel panels between 25-500-micron film thickness, preferably 45-300-micron film thickness, primed with inventive two-component rust encapsulating polymeric penetrant having vinyl and oxidative cure mechanisms and addition of 30% HA additive by wt. on total wt. % solids of two-component inventive primer formulation, applied at 25-250-micron film thickness, preferably 28-150-micron film thickness and allowed to cure at 25° C. for a period of 7 days prior to testing.

### Example 8

First component of an inventive formulation is prepared by adding 8.62 g polyester prepolymer of hydroxyl equivalent weight of 200-280 g/eq to 5.14 g of polyester prepolymer with hydroxyl equivalent weight of 350-450 g/eq. 0.08 g of commercial flow and leveling additive, 0.46 g of pigment wetting and dispersing additive, 20.91 g of titanium dioxide, 0.36 g of fumed silica, 12.64 g of HA additive and 41.05 g of parachlorobenzotrifluoride are added to the mixture. 0.14 g of 10% solution of dibutyltin dilaurate in toluene is added to above mixture in letdown stage. For the preparation of second component, 10.63 g of diisocyanate oligomer solution is prepared by adding 0.77 g parachlorobenzotrifluoride solvent to 9.83 g of hexamethylene diisocyanate trimer having NCO equivalent 180-250 g/eq. Second component is thoroughly mixed with first component for form inventive formulation having pot life of 8 hours. Inventive composition is applied on shot blasted cold rolled steel panels between 25-500-micron film thickness, preferably 45-300-micron film thickness, primed with inventive two-component rust encapsulating polymeric penetrant having vinyl and oxidative cure mechanisms and addition of 30% HA additive by wt. on total wt. % solids of two-component inventive primer formulation, applied at 25-250-micron film thickness, preferably 28-150-micron film thickness and allowed to cure at 25° C. for a period of 7 days prior to testing.

### Example 9

First component of inventive composition is prepared by adding 0.08 g of commercial flow and leveling additive and 0.15 g of wetting and dispersing additive to 25.66 g of polyester prepolymer. 52.01 g of parachlorobenzotrifluoride solvent is added to mixture along with 18.49 g of HA additive. 3.47 g of titanium dioxide pigment is added to mixture and ground to Hegman grind scale of 7+. 0.13 g of 10% solution of dibutyltin dilaurate in toluene is added to above mixture in letdown stage. 12.83 g of diisocyanate oligomer is added as second component to first component. Inventive formulation has pot life of 8 hours. Inventive composition is applied on shot blasted cold rolled steel panels between 25-500-micron film thickness, preferably 45-300-micron film thickness, primed with inventive two-component rust encapsulating polymeric penetrant having vinyl and oxidative cure mechanisms and addition of 30% HA additive by wt. on total wt. % solids of two-component inventive primer formulation, applied at 25-250-micron film thickness, preferably 28-150-micron film thickness and allowed to cure at 25° C. for a period of 7 days prior to testing.

### Example 10

Commercial two-component polyurethane paint is applied on shot blasted cold rolled steel panels between 25-500-micron film thickness, preferably 45-300-micron film thickness, primed with commercial two component zinc-rich epoxy primer applied at 25-250-micron film thickness, preferably 28-150-micron film thickness and allowed to cure at 25° C. for a period of 7 days prior to testing.

### Example 11

The coated blasted cold rolled steel coupons prepared in Examples 1 to 10 are subjected to various tests. Test coupons are prepared as above or detailed below are subjected to the following tests on separate coupons to determine coating attributes:
Specular gloss in accordance with ASTM D523
Spectrophotometric color coordinates—L, A, B, in accordance with ASTM D2805-11
Positest pull-off adhesion test, bond strength (psi), in accordance with ASTM D4541
Solvent, chemical, Methyl Ethyl Ketone resistance in accordance with ASTM D5402
Direct and reverse impact resistance in accordance with ASTM D2794
Contact angle using secile drop method
Taber abrasion resistance in accordance with ASTM D4060
Dry film thickness in accordance with ASTM D1400 and ASTM D7091
Crosshatch adhesion (X-cut) in accordance with ASTM D3359
Pencil hardness test in accordance with ASTM D3363 based on gouge hardness testing and scratch hardness testing

TABLE 1
Optical properties of various primers and topcoat systems.

| | Gloss | Spectrophotometric |
|---|---|---|
| | ASTM D523 | color |
| Example # | 20°/60°/80° | L*/a*/b* |
| Ex.1 | 0.7/1.8/3.6 | 73.1/−1.6/3.3 |
| Ex.2 | 1.3/3.2/9.8 | 96.5/−0.0/1.9 |
| Ex.3 | 1.3/4.2/10.5 | 90.7/−0.4/4.1 |
| Ex.4 | 0.7/1.8/3.6 | 73.1/−1.6/3.3 |
| Ex.5 | 1.3/3.2/9.8 | 96.5/−0.0/1.9 |
| Ex.6 | 1.3/4.2/10.5 | 90.7/−0.4/4.1 |
| Ex.7 | 0.7/1.8/3.6 | 73.1/−1.6/3.3 |
| Ex.8 | 1.3/3.2/9.8 | 96.5/−0.0/1.9 |
| Ex.9 | 1.3/4.2/10.5 | 90.7/−0.4/4.1 |
| Ex.10 | 0.3/1.0/3.0 | 47.9/−0.39/−3.9 |

TABLE 2
Positest pull-off adhesion/bond strength of various primers
and topcoat systems

| | Positest pull-off adhesion test (ASTM D4541) | | | | |
|---|---|---|---|---|---|
| Top | Reading | Reading | Reading | Average | |
| coat | 1 (psi) | 2 (psi) | 3 (psi) | (psi) | Comments |
| Ex.1 | 337 | 407 | 316 | 353 | Cohesion failure in |
| | | | | | topcoat |
| Ex.2 | 572 | 570 | 573 | 572 | Cohesive failure in |
| | | | | | topcoat, near to primer |
| | | | | | topcoat interface |
| Ex.3 | 707 | 667 | 712 | 695 | 10% topcoat cohesion |
| | | | | | failure, 90% glue |
| | | | | | failure |
| Ex.4 | 411 | 413 | 429 | 418 | Cohesion failure in |
| | | | | | topcoat |
| Ex.5 | 363 | 388 | 390 | 380 | Cohesive failure in |
| | | | | | primer, near to |
| | | | | | substrate |
| Ex.6 | 522 | 558 | 478 | 519 | 20% primer cohesion |
| | | | | | failure, 80% glue |
| | | | | | failure |
| Ex.7 | 406 | 376 | 371 | 384 | Cohesion failure in |
| | | | | | topcoat |
| Ex.8 | 414 | 376 | 370 | 387 | Cohesive failure in |
| | | | | | primer |
| Ex.9 | 752 | 850 | 555 | 719 | 10% topcoat cohesion |
| | | | | | failure, 90% glue |
| | | | | | failure |

TABLE 3
MEK double rubs (ASTM D5402) and impact
resistance (ASTM D2794)

| | MEK DR | Impact resistance (ASTM D2794) | |
|---|---|---|---|
| Top | ASTM | Direct | Reverse |
| coat | D5402 | (Lb. Inch) | (lb. Inch) |
| Ex.1 | <100 | 100 | 170 |
| Ex.2 | >1,000 | 170 | 30 |
| Ex.3 | >1,000 | 170 | 170 |
| Ex.4 | <100 | 30 | 30 |
| Ex.5 | >1,000 | 20 fail, | 20 fail, no cracks |
| | | cracks | but adhesion failure |
| Ex.6 | >1,000 | 20 | 50 |
| Ex.7 | <100 | 100 | 50 |
| Ex.8 | >1,000 | 80 | 20 |
| Ex.9 | 752 | 110 | 130 |
| Ex.10 | >500 | 170 | 110 |

TABLE 4
Abrasion resistance of various primer and topcoat systems.

| | Wt. loss in (mg) after | Contact angle | |
|---|---|---|---|
| | 1,000 cycles of | Before | After |
| | taber abrasion | taber | taber |
| Top coat | ASTM D4060 | abrasion | abrasion |
| Ex.1 | 3.81 | 123.46 | 132.46 |
| Ex.2 | 84.14 | 122.76 | 111.05 |
| Ex.3 | 2.24 | 113.75 | 136.10 |
| Ex.4 | 3.79 | 122.76 | 131.78 |
| Ex.5 | 82.56 | 121.47 | 110.68 |
| Ex.6 | 2.29 | 114.65 | 137.53 |
| Ex.7 | 4.01 | 124.76 | 132.74 |
| Ex.8 | 79.67 | 121.47 | 109.87 |
| Ex.9 | 2.21 | 124.65 | 137.63 |
| Ex.10 | 3.62 | 106.60 | 85.10 |

TABLE 5
Contact angle of various systems

| Example # | Contact Angle |
|---|---|
| Ex.1 | 127.02° |
| Ex.2 | 125.9° |
| Ex.3 | 111.55° |
| Ex.10 | 106.6° |

TABLE 6
Physical properties of various primers and topcoats

| | Dry film | Crosshatch | | |
|---|---|---|---|---|
| | thickness | adhesion | Pencil hardness | |
| | (Primer + | (X-cut) | (ASTM D3363) | |
| | Topcoat) | ASTM | Scratch | Gouge |
| Top coat | in mils | D3359 | hardness | hardness |
| Ex. 1 | 5.5 + 4 | 4B | 3H | 3H |
| Ex.2 | 5.5 + 4.5 | 4B | 3H | 3H |
| Ex.3 | 4.4 + 5 | 4B | 4H | 4H |
| Ex.4 | 4.5 + 5.5 | 4B | 3H | 3H |
| Ex.5 | 4.5 + 5.5 | 4B | 3H | 3H |
| Ex.6 | 4.5 + 5.5 | 4B | 3H | 3H |
| Ex.7 | 5 + 5 | 4B | 4H | 4H |
| Ex.8 | 5 + 5 | 4B | 3H | 3H |
| Ex.9 | 5 + 5 | 4B | 4H | 4H |
| Ex.10 | 5 + 5 | 4B | 4H | 3H |

### Example 12

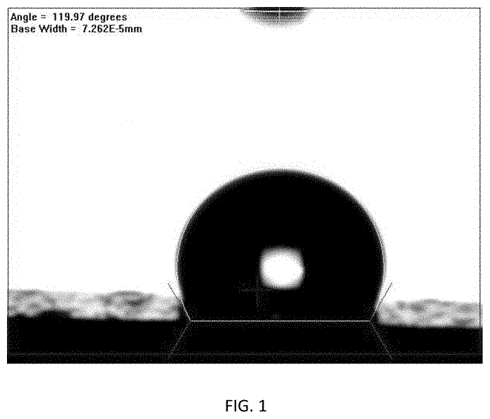

First component of an inventive formulation is prepared by adding 15.50 g polyester prepolymer of hydroxyl equivalent weight of 200-280 g/eq to 9.25 g of polyester prepolymer with hydroxyl equivalent weight of 350-450 g/eq. 0.15 g of commercial flow and leveling additive, 0.83 g of pigment wetting and dispersing additive, 37.58 g of titanium dioxide, 0.64 g of fumed silica, 1.5 g of Methyl Amyl Ketone, 1.88 g of aromatic 100, 5.61 g of PM Acetate are added to the mixture. 0.26 g of 10% solution of dibutyltin dilaurate in toluene is added to above mixture in letdown stage. 30% HA additive was added on total wt % solids of inventive formulation. For the preparation of second component, 19.06 g of diisocyanate oligomer solution is prepared by adding 1.39 g n-butyl acetate solvent to 17.66 g of hexamethylene diisocyanate trimer having NCO equivalent 180-250 g/eq. Second component is thoroughly mixed with first component for form inventive formulation having pot life of 8 hours. Inventive composition is applied on Zinc-nickel coated steel panels between 25-500-micron film thickness, preferably 45-300-micron film thickness, primed with inventive two-component rust encapsulating polymeric penetrant having vinyl and oxidative cure mechanisms and addition of 30% HA additive by wt. on total wt. % solids of two-component inventive primer formulation, applied at 25-250-micron film thickness, preferably 28-150-micron film thickness and allowed to cure at 25° C. for a period of 7 days prior to testing. FIG. 1. shows formed contact angle of 4 μL deionized water droplet on hydrophobic coating using HA additive.

### Example 13

An inventive topcoat composition described in Example 12 is prepared without addition of HA additive. Inventive composition is applied on Zinc-nickel coated steel panels between 25-500-micron film thickness, preferably 45-300-micron film thickness, primed with inventive two-component rust encapsulating polymeric penetrant having vinyl and oxidative cure mechanisms, applied at 25-250-micron film thickness, preferably from 28 to 150-micron film thickness and allowed to cure at 25° C. for a period of 7 days prior to testing.

### Example 14

An inventive topcoat composition described in Example 12 is prepared without addition of HA additive. Inventive composition is applied on Zinc-nickel coated steel panels between 25-500-micron film thickness, preferably 45-300-micron film thickness, primed with inventive two-component rust encapsulating polymeric penetrant having vinyl and oxidative cure mechanisms and addition of 30% HA additive by wt. on total wt. % solids of two-component inventive primer formulation, applied at 25-250-micron film thickness, preferably 28-150-micron film thickness and allowed to cure at 25° C. for a period of 7 days prior to testing.

### Example 15

Inventive composition described in Example 5 is applied on zinc-nickel coated steel coupons at dry film thickness between 125-175 microns.

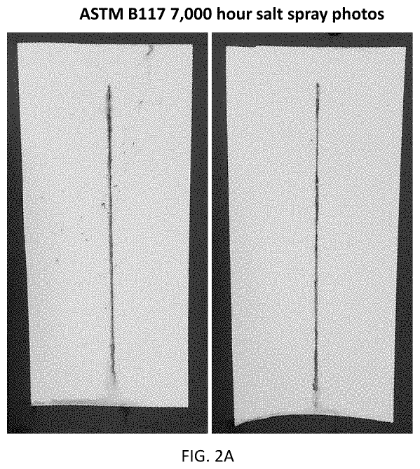

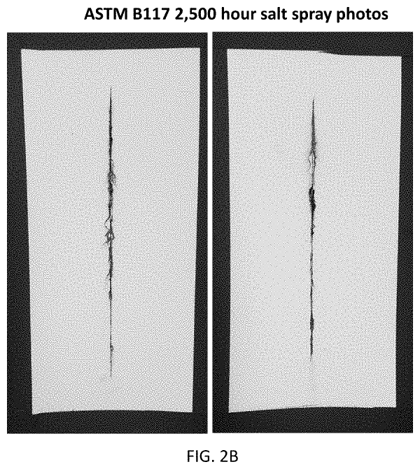

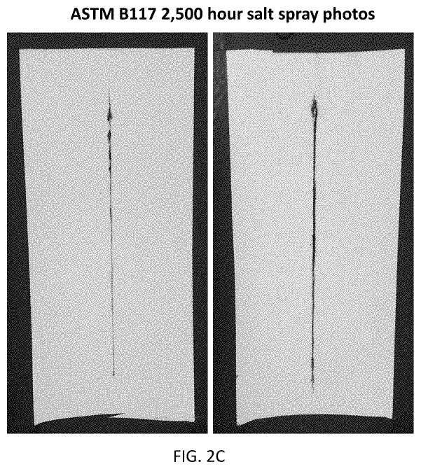

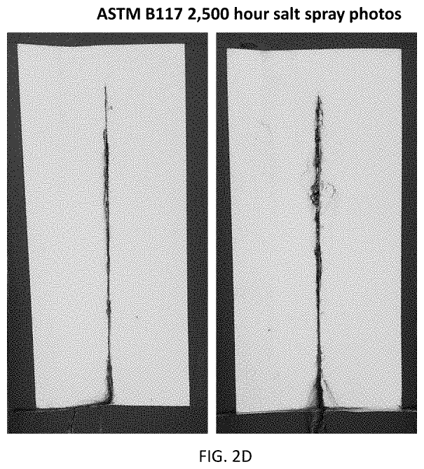

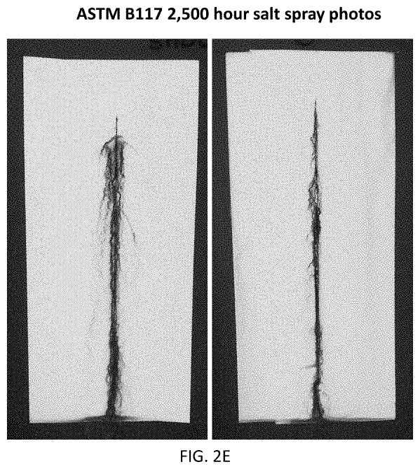

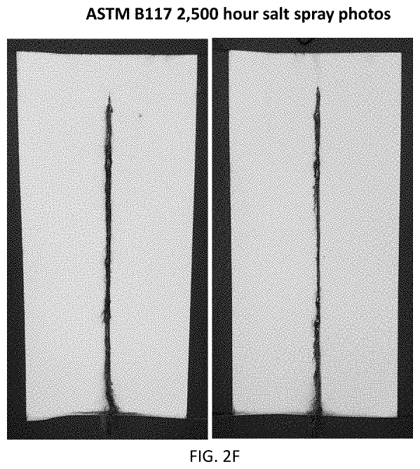

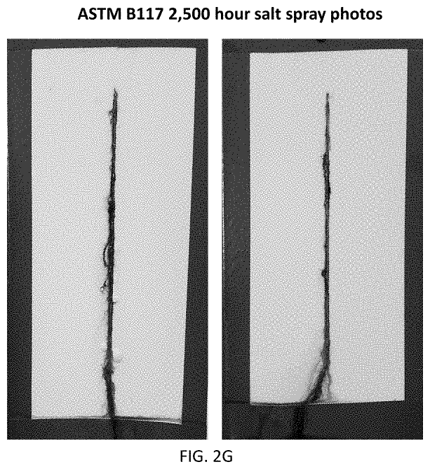

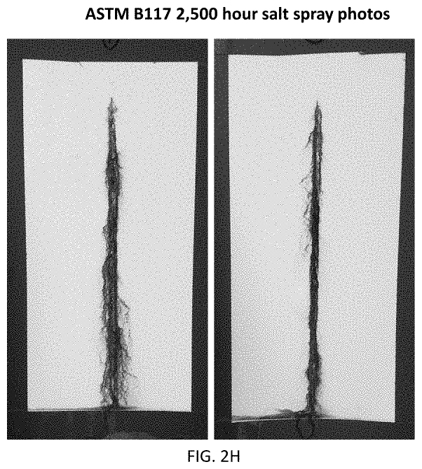

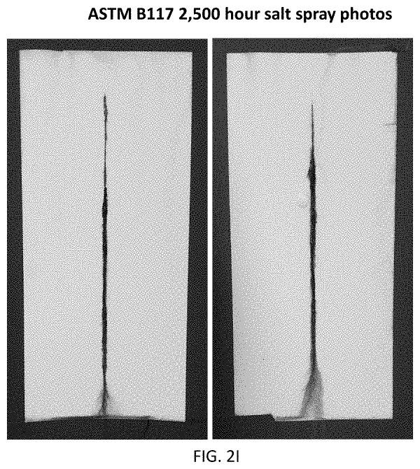

Results of salt spray testing thereof according to ASTM B117 for 2,500 hours are detailed with respect to FIGS. 2A-21 and reported in Table 7.

TABLE 7
ASTM B117 Salt spray rating of various primers and topcoats after 2,500 hours of salt-fog exposure.

| | | Field | | | | | | | |
|---|---|---|---|---|---|---|---|---|---|
| | | Blistering | Field | Scribe | Scribe | Scribe | | | |
| Ex. | Panel | No., | Corrosion | Rating | Blisters | Creep | | No, | |
| # | Id | severity | Rating | Description | Rating | (mm) | Rating | severity | Rating |
| Ex. | Panel | 6 VF | 8 | Spot | 8 | 0-0.5 | 9 | 10 | 10 |
| 1 | 1 | | | rusting | | | | | |
| | Panel | 6 F | 9 | Spot | 9 | 0 | 10 | 10 | 10 |
| | 2 | (ONE | | rusting | | | | | |
| | | SPOT) | | | | | | | |
| Ex. | Panel | 2F | 8 | Spot | 9 | 0-0.5 | 9 | 2F | 8 |
| 2 | 1 | (ONE | | rusting | | | | (one | |
| | | SPOT) | | | | | | spot) | |
| | Panel | 4F | 8 | Spot | 9 | 0-0.5 | 9 | 10 | 10 |
| | 2 | (ONE | | rusting | | | | | |
| | | SPOT) | | | | | | | |
| Ex. | Panel | 6 F | 9 | No | 10 | 0 | 10 | 6 VF | 8 |
| 3 | 1 | (ONE | | corrosion | | | | | |
| | | SPOT) | | | | | | | |
| | Panel | 6 VF | 8 | No | 10 | 0-0.5 | 9 | 10 | 10 |
| | 2 | | | corrosion | | | | | |
| Ex. | Panel | 10 | 10 | No | 10 | 0.5-1 | 8 | 10 | 10 |
| 4 | 1 | | | corrosion | | | | | |
| | Panel | 10 | 10 | No | 10 | 0.5-1 | 8 | 10 | 10 |
| | 2 | | | corrosion | | | | | |
| Ex. | Panel | 10 | 10 | No | 10 | 1-2 | 7 | 10 | 10 |
| 5 | 1 | | | corrosion | | | | | |
| | Panel | 10 | 10 | No | 10 | 1-2 | 7 | 10 | 10 |
| | 2 | | | corrosion | | | | | |
| Ex. | Panel | 10 | 10 | No | 10 | 0.5-1 | 8 | 10 | 10 |
| 6 | 1 | | | corrosion | | | | | |
| | Panel | 10 | 10 | No | 10 | 0.5-1 | 8 | 10 | 10 |
| | 2 | | | corrosion | | | | | |
| Ex. | Panel | 10 | 10 | No | 10 | 0.5-1 | 8 | 2F | 2 |
| 7 | 1 | | | corrosion | | | | | |
| | Panel | 10 | 10 | No | 10 | 0.5-1 | 8 | 2F (2 | 7 |
| | 2 | | | corrosion | | | | spots) | |
| Ex. | Panel | 10 | 10 | No | 10 | 1-2 | 7 | 10 | 10 |
| 8 | 1 | | | corrosion | | | | | |
| | Panel | 10 | 10 | No | 10 | 1-2 | 7 | 10 | 10 |
| | 2 | | | corrosion | | | | | |
| Ex. | Panel | 10 | 10 | No | 10 | 0.5-1 | 8 | 10 | 10 |
| 9 | 1 | | | corrosion | | | | | |
| | Panel | 10 | 10 | No | 10 | 0.5-1 | 8 | 2F | 8 |
| | 2 | | | corrosion | | | | (one | |
| | | | | | | | | spot) | |

In Table 7, the results of the Field Blistering. Scribe Creep and Scribe Ratings are in accordance with ASTM D1654, the Field Corrosion Ratings are in accordance with ASTM D610 and the Blister rating are in accordance with ASTM D714. In Table 7, “F” means “Few” and “VF” means “very few” blisters. The numbers listed in the “Rating” columns are ratings based on a 0 to 10 scale, with 0 being the worst score and 10 being the best score.

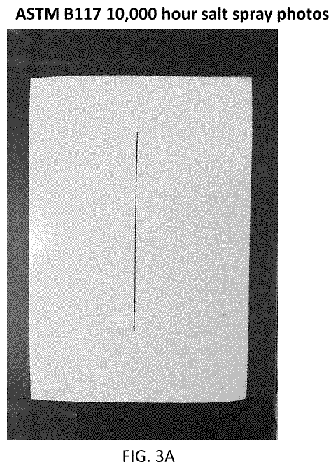

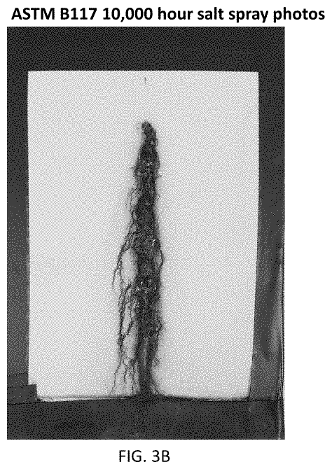

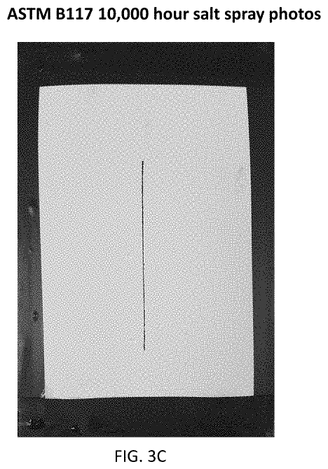

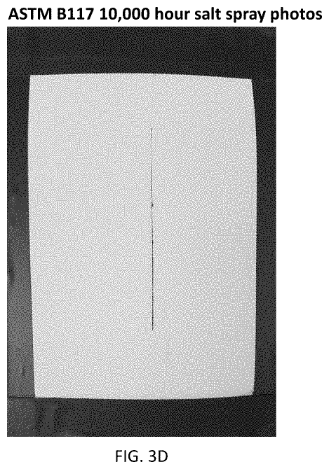

Coupons coated with Examples 14, 15, 13 & 12 are exposed to 10,000 hours of salt-fog. Results of salt spray testing thereof according to ASTM B117 for 10.000 hours are detailed with respect to FIGS. 3A-3D and reported in Table 8.

TABLE 8
Salt spray rating after 10,000 hours of salt-fog exposure

| | | | | Field | | | | | |
|---|---|---|---|---|---|---|---|---|---|
| | | Field Blistering | | Corrosion | | Scribe Rating | | Scribe Blisters | |
| Coating | | No., | | | | Scribe Creep | | No, | |
| Identity | Ex. | severity | Rating | Description | Rating | (mm) | Rating | severity | Rating |
| RA (w/o HA) + | 13 | 0, None | 10 | None | 10 | 0 | 10 | 0, None | 10 |
| 2K PU | | | | | | | | | |
| Topcoat (w/o | | | | | | | | | |
| HA) | | | | | | | | | |
| RA (w/o HA) + | 15 | 0, None | 10 | None | 10 | 16 | 0 | 0, None | 10 |
| 2K PU | | | | | | | | | |
| Topcoat (w HA) | | | | | | | | | |
| RA (w/ HA) + | 14 | 0, None | 10 | None | 10 | 0 | 10 | 2-4, | 2.5 |
| 2K PU | | | | | | | | Medium | |
| Topcoat (w/o | | | | | | | | | |
| HA) | | | | | | | | | |
| RA (w/ HA) + | 12 | 0, None | 10 | None | 10 | 0 | 10 | 0, None | 10 |
| 2K PU | | | | | | | | | |
| Topcoat (w/ HA) | | | | | | | | | |

In Table 8, the results of the Field Blistering, Scribe Creep. and Scribe Ratings are in accordance with ASTM D1654, the Field Corrosion Ratings are in accordance with ASTM D610, and the Blister rating are in accordance with ASTM D714. In Table 8, the numbers listed in the “Rating” columns are ratings based on a 0 to 10 scale, with 0 being the worst score and 10 being the best score.

Free films of inventive topcoat formulations described in examples 1, 2 and 3 were prepared and tested for water/moisture permeation using a Payne cup in accordance with ASTM D1653. Results of which are reported in Table 9.

TABLE 9
Moisture permeability data before and after sanding coupons
with 800 grit sand paper

| | Before | | After | |
|---|---|---|---|---|
| | sanding film | Water | sanding film | Water |
| | thickness | evaporation | thickness | evaporation |
| Examples | (Microns) | (g) | (Microns) | (g) |
| Ex. 1 | 95 | 0.2159 | 82 | 0.1761 |
| Ex. 2 | 92 | 0.1614 | 98 | 0.0792 |
| Ex. 3 | 95 | 0.159 | 92 | 0.1118 |

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A two-part polymerizable formulation that upon mixing comprises:
a saturated aliphatic polyester prepolymer present in an amount of between 10 to 65 weight percent of the total formulation having a viscosity of between 100 and 955 cP at 25° C.;
an organic solvent present in an amount of between 25 to 55 weight percent of the total formulation; and
hexamethylene diisocyanate trimer, isophorone diisocyanate dimer or trimer, toluene diisocyanate or methylene diphenyl diisocyanate, or combinations thereof is present in an amount of 17 to 25 weight percent of the total formulation, the formulation having an overall viscosity that allows the formulation to penetrate a substrate to which the formulation is applied.

2. The formulation of claim 1 wherein the two-part polymerizable formulation forms a coating when applied to the substrate.

3. The formulation of claim 2 wherein the substrate is unprimed.

4. The formulation of claim 2 wherein the substrate is any of oxidized aluminum, anodized aluminum, picked steel, stainless steel, hot dip galvanized steel, cold rolled steel, hot rolled steel, GALFAN®, ZINCALUME®, cement, concrete, wood, painted wood, fabric, plastic, drywall, or fiberboard.

5. The formulation of claim 1 wherein the low molecular weight saturated aliphatic polyester prepolymer has a hydroxyl equivalent weight between 150 and 1,187 g/eq.

6. The formulation of claim 1 wherein the saturated aliphatic polyester prepolymer is a diol, a triol, or a combination thereof.

7. The formulation of claim 1 wherein the saturated aliphatic polyester prepolymer has an acid value between 0.01 and 0.5.

8. The formulation of claim 1 wherein the saturated aliphatic polyester prepolymer has a specific gravity between 9 and 10.14 lb/gal at 25° C.

9. The formulation of claim 1 wherein the saturated aliphatic polyester prepolymer has a viscosity of such polyester prepolymer may be between 100 and 955 cP at 25° C.

10. The formulation of claim 1 wherein the organic solvent is acetone, methyl acetate, ethyl acetate, butyl acetate, t-butyl acetate, dimethyl carbonate, 2-amino-2-methyl-1 propanol, parachlorobenzotrifluoride, toluene, butanol, ethyl ethyl ketone, xylene, tetrahydrofuran, aromatic 100, 150, or 200, C₂-C₆ acetates including n-propyl acetate, and n-hexyl acetate and 2-butoxy-ethanol, other ethylene or propylene glycol based ether solvents, or a combination thereof.

11. The formulation of claim 1 further comprising at least one of: flow modifier additive of an acrylic polymer with an acid value between 0.5 and 1.99, a pigment, a filler, an extender, or a pigment.

12. The formulation of claim 1 further comprising a cure accelerator present in an amount of between 0.01 to 0.2 weight percent of the total formulation.

13. The formulation of claim 1 further comprising a two component system in which one or more of the components are provided in a second package.

14. The formulation of claim 1 further comprising a low surface tension solvent of a cyclosiloxane, a perfluoralkane, a polydimethyl siloxane, or a combination thereof.

15. A process of forming a polymerized coating on an article comprising:
applying a formulation according to claim 1 to a substrate of the article; and
allowing sufficient time and temperature for said solvent to evaporate to accelerate a rate of cure of said polymerizable compound to form a polymerized coating on the article.

16. The process of claim 15 wherein the formulation is applied as a pressurized aerosol atomized air spray, brush, roller or airless spray, dip or reverse roll coating.

17. The process of claim 15 wherein the substrate is overlayered with a corrosion layer and the applying step occurs absent prior corrosion layer removal and the formulation penetrates beneath the corrosion layer before cure and at least partially embeds the corrosion layer in the polymerized coating.

18. The process of claim 15 wherein the polymerized coating forms a moisture and air barrier.

19. The process of claim 15 further comprising adding a dye or pigment or filler to the formulation prior to the applying step.

20. The process of claim 15 wherein the polymerized coating as a contact angle of up to 160 degrees upon applying water to the polymerized coating.
